(19) United States
(12) Patent Application Publication
(10) Pub. No.: US 2022/0238966 A1
(43) Pub. Date: Jul. 28, 2022

(54) A BATTERY ASSMEBLY

(71) Applicant: BATTERY GRAPHENE CORP PTY LTD, Wavell Heights, Queensland (AU)

(72) Inventor: Dominic SPOONER, Brisbane, Queensland (AU)

(21) Appl. No.: 17/617,464

(22) PCT Filed: Jun. 16, 2020
(86) PCT No.: PCT/AU2020/050604

§ 371 Date: Dec. 8, 2021

(30) Foreign Application Priority Data
Jun. 17, 2019 (AU) 2019902102
Oct. 24, 2019 (AU) 2019904000

(51) Int. Cl. H01M 50/536; H01M 4/66; H01M 50/213

(52) U.S. Cl. CPC H01M 50/536; H01M 50/213; H01M 4/663

(57) ABSTRACT

The present invention relates to a battery pack including batteries. A first current collector is provided for engaging with first electrodes of the batteries. The battery pack further includes a second current collector for engaging with second electrodes of the batteries. Fastening means is provided for fastening the current collectors together. Advantageously, the battery pack is assembled by fitting the current collectors together, without the need for screws or other threaded fasteners.

### TECHNICAL FIELD

The present invention relates to a battery assembly.

### BACKGROUND

The reference to any prior art in this specification is not, and should not be taken as an acknowledgement or any form of suggestion that the prior art forms part of the common general knowledge.

Battery clamshells are a type of battery assembly commonly used in electric vehicles. The clamshell includes batteries with welded tabs at top and bottom. Plastic layers are provided to hold the batteries and a serpentine cooling system runs though the clamshell.

The preferred embodiment provides a less complex battery assembly which is cost effective to produce, requiring simpler tooling, lesser assembly operations and fewer parts.

### SUMMARY OF THE INVENTION

According to one aspect of the present invention, there is provided a battery pack including:

batteries;

a first current collector for engaging with first electrodes of the batteries;

a second current collector for engaging with second electrodes of the batteries; and

fastening means for fastening the current collectors together.

Advantageously, the battery pack may be assembled by snap fitting the current collectors together, without the need for screws or other threaded fasteners. Preferably, the current collectors are snap fastened together in electrical connection with the batteries located there-between.

The fastening means may optionally be a snap fastening means, or alternatively include a slide, latch, or even thermalplast. The snap fastening means may include one or more posts extending between the current collectors. The posts may extend between gaps formed by adjoining batteries. Each post may include a resilient head for squeezably inserting through a current collector. The head may include a tapered apex to facilitate insertion. The head may be split. Each post may fixedly extend from the other current collector, preferably being integrally formed with the other current collector. The snap fastening means may be releasable. The snap fastening means may include one or more male and female parts.

Each current collector may include graphene. Each current collector may include an inner layer; and an outer layer adjacent the inner layer. Each current collector may include a polymeric material, thereby avoiding metal to metal welding operations thus representing a large cost savings during assembly and permitting an easier battery replacement process.

The inner layer may be electrically conductive and engage with the electrodes. The inner layer may be thermally conductive. The inner layer may include any one or more of polymeric material, graphene, metal powder, nickel and/or copper.

The outer layer may be formed of non-electrically conductive material.

According to another aspect of the present invention, there is provided a battery pack housing including:

a first current collector for engaging with first electrodes of batteries;

a second current collector for engaging with second electrodes of the batteries; and

fastening means for fastening the current collectors together.

According to another aspect of the present invention, there is provided a current collector for a battery pack housing, the current collector including graphene.

According to another aspect of the present invention, there is provided a method for assembling a battery pack, the method including:

fastening a first current collector for engaging with first electrodes of the batteries to a second current collector for engaging with second electrodes of the batteries.

The method may involve forming each current collector. The step of forming may involve joining an inner layer and an outer layer. The method of forming the inner layer may involve initially forming a solid panel, and then bonding a liquid to the solid panel which advantageously increases electrical conductivity.

According to one aspect of the present disclosure, there is provided a battery assembly including:

batteries including cases forming first electrodes; and

an electrically and thermally conductive current collector which is used to connect to second electrodes of the batteries and to a heatsink or thermal block.

Advantageously, the assembly of the preferred embodiment is less complex than clamshells requiring fewer parts, and not needing a serpentine cooling system.

Preferably, the current collector includes graphene. The current collector may include polymeric material. The current collector may have a thermal conductivity more than 3000 W/mK. The current collector may have an electrical conductivity of more than 100% International Annealed Copper Standard (IACS).

The assembly may include a linear array of batteries. The batteries may be electrically connected in parallel. The current collector may include a sheet extending adjacent the array.

The current collector may include a support for supporting the batteries. The support may include at least one foot. The current collector may include one or more arms coupled to the second electrodes. The current collector may be adhered to the second electrodes with adhesive. The adhesive may include graphene. The current collector may be integrally formed.

The assembly may include a cooler for thermally coupling to the support. The cooling assembly may include a block or plate incorporating liquid or thermoelectric cooling.

Each case may engage or be electrically coupled with an adjacent case to form an electrical connection.

The first electrode may be a negative electrode whereas the second electrode may be a positive electrode. Each battery may include a dry cell battery.

The assembly may be used in an electric vehicle. The assembly may be used in stationary energy storage systems. The assembly may be used in manned or unmanned aircraft. The assembly may further include connection tabs to facilitate connection to a current collector.

According to another aspect of the present disclosure, there is provided a battery block including connected battery assemblies. The battery assemblies may be electrically connected in series. The battery assemblies may be adhered together with adhesive. The adhesive may include graphene. The block may include current collectors separating rows of batteries.

According to another aspect of the present disclosure, there is provided a battery assembly including:

a battery including a first electrode; and

an electrically and thermally conductive current collector forming a second electrode of the battery.

Optionally, at least one heatsink is attached to the current collector through a layer of electrically insulating thermal interface material.

According to another aspect of the present invention, there is provided a battery assembly including:

one or more batteries; and

a heatsink which is used to sink heat from the batteries.

The heatsink may include one or more conduits for conveying fluid. The conduits may be aligned with respective batteries. The heatsink may include a receptacle for receiving the batteries. The conduits and receptacle may be integrally formed (e.g. molded). The receptacle may be an electrical insulator, although is thermally conductive. The heatsink may include a pair of electrically conductive terminals for engaging with respective electrodes of the batteries. The terminals may be embedded in the receptacle. The heatsink may be a clamp.

Any of the features described herein can be combined in any combination with any one or more of the other features described herein within the scope of the invention.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 shows front and rear perspective views of an electric vehicle battery assembly;

FIG. 2 shows perspective views of battery blocks including the battery assembly of FIG. 1;

FIG. 3 shows an exploded side view of an electric vehicle battery pack in accordance with an embodiment of the present invention;

FIG. 4 shows a plan view of the top of a housing segment of the battery pack of FIG. 3 showing the fastening means; and

FIG. 5 shows the fastened segment of the battery pack of FIG. 4; and

FIG. 6 shows a rear perspective views of an electric vehicle battery assembly in accordance with another embodiment.

### DETAILED DESCRIPTION OF PREFERRED EMBODIMENTS

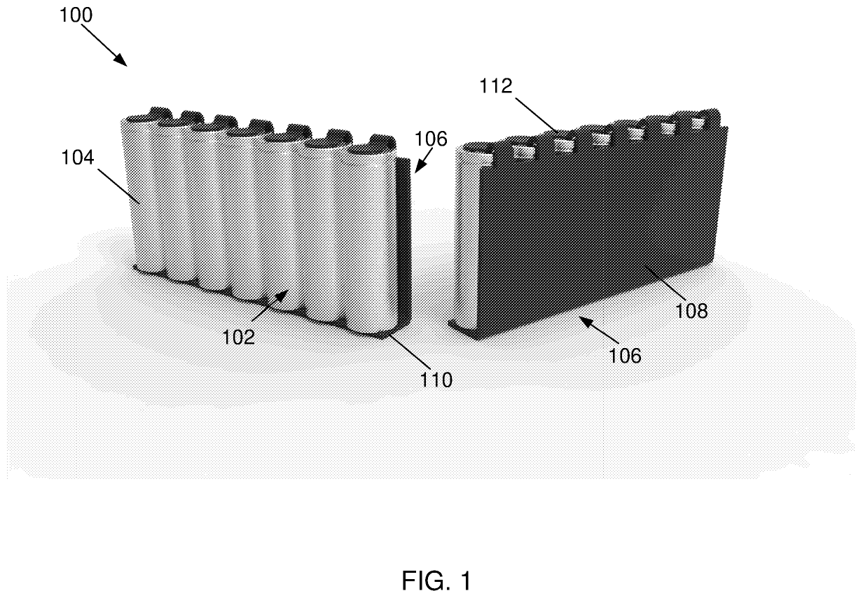

There is provided an electric vehicle battery assembly 100 as shown in FIG. 1. The assembly 100 includes lithium ion cylindrical cells 102 with outer cylindrical cases 104 that form negative (first) electrodes. Each case 104 may engage or be electrically coupled with a current collector 106 to form an electrical connection.

The assembly 100 further includes an electrically and thermally conductive current collector 106 interconnecting positive (second) electrodes running along the centre of the batteries 102. The heatsink 106 includes graphene and polymeric material engineered to meet or exceed the performance of copper or equivalent materials.

Advantageously, the assembly 100 is less complex than clamshells requiring fewer parts, and does not need a serpentine cooling system owing to superior thermal conductivity of the current collector 106.

The assembly 100 includes a linear array of electrically parallel batteries 102, and the positive heatsink 106 is electrically isolated from the negative cases 104. The current collector 106 is lined with an electrically insulating backing sheet 108 extending adjacent the array of batteries 102 to isolate the negative case from the current collector 106.

The integrally formed heatsink 106 may also include a foot which extends perpendicular to the main connective surface for the purpose of attaching a cooling plate or secondary heatsink (not shown). The foot acts as the thermal bridge between the passively cooled module 100 and the actively cooled secondary heatsink which typically takes the form of an external block. The actively cooled block can be integrated into the foot. The upper end of the heatsink 106 includes arms 112 with terminals for coupling to respective positive electrodes of the batteries 102. The arms 112 may be electrically conductively adhered to the positive electrodes with adhesive including graphene.

The assembly 100 also includes a base cooler (not shown) for thermally coupling to the foot support 110. The cooler may include a block or plate incorporating liquid or thermoelectric cooling systems.

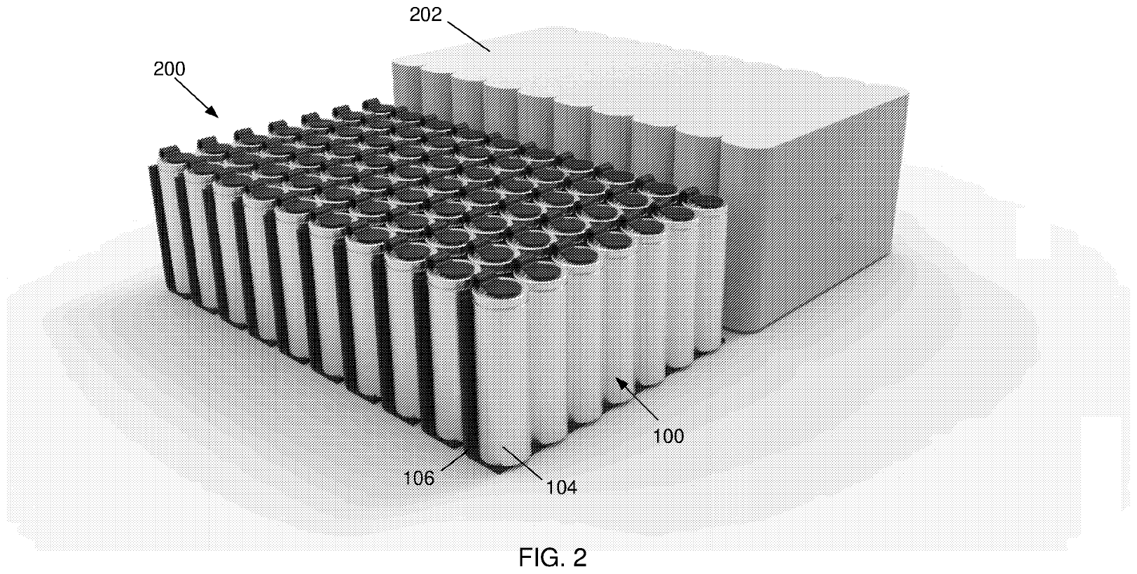

FIG. 2 shows a battery block 200 including electrically inter-connected battery assemblies 100. The battery assemblies 100 are adhered together in electrical series with an electrically conductive adhesive including graphene. In this manner, the heatsink 106 of one assembly 100 is adhered to the cases 104 of the next assembly 100. The heatsinks 106 are disposed in an alternating manner and separate rows of batteries 102.

The front and rear assemblies 100 in the block 200 further include connection tabs (not shown) to facilitate connection to a current collector. The block 200 is typically overmolded with an insulator 202 leaving the connection tabs exposed.

The modular block 200 and module assembly 100 provide approximately 15% energy/unit mass improvement (From 160 Wh/kg to >220 Wh/kg) and approximately 25% volumetric energy density gain over known batteries. In addition, the block 200 and assembly 100 provide considerable cost saving of up to 20% when compared with known prismatic modules.

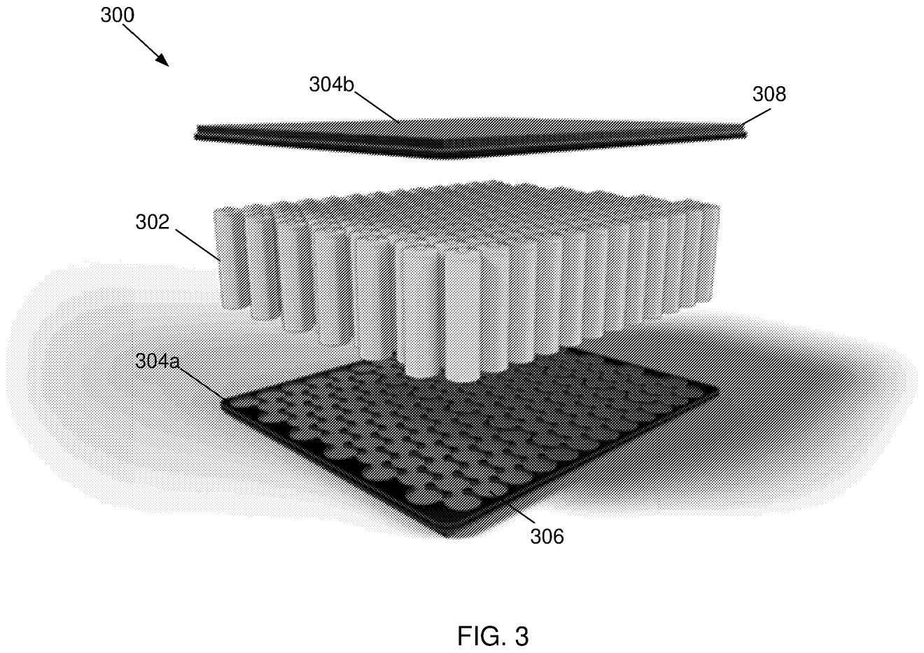

FIG. 3 shows an electric vehicle battery pack 300. The battery pack 300 includes a two-dimensional array of batteries 302. A lower current collector 304a is provided for engaging with negative (first) electrodes of the batteries 302. The battery pack 300 also includes an upper current collector 304b for engaging with positive (second) electrodes of the batteries 302.

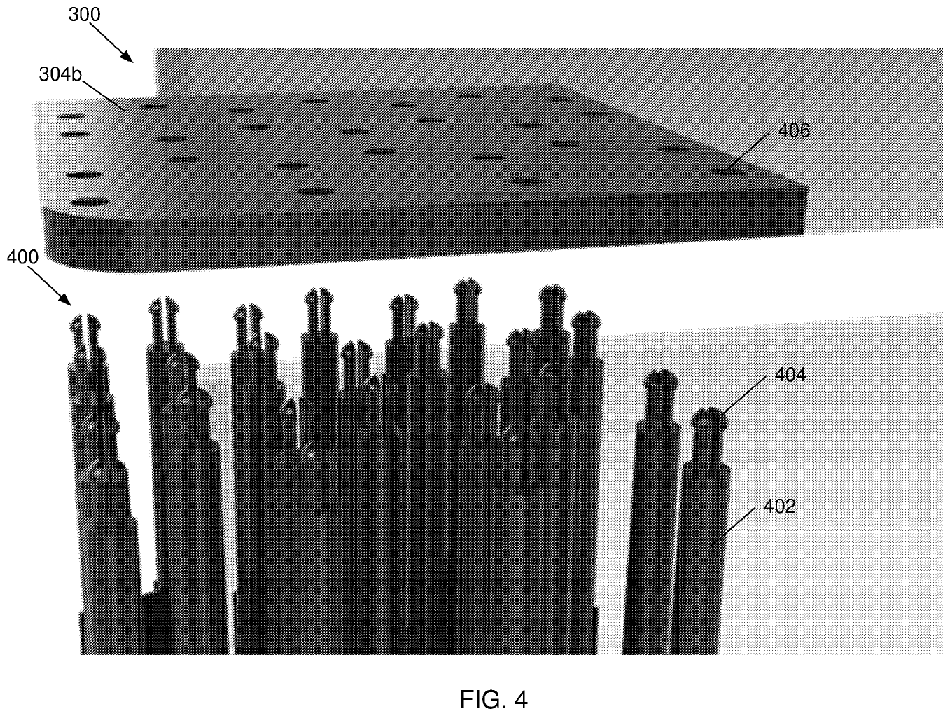

As can best be seen in FIG. 4, snap fastening means 400 is provided for snap fastening the current collectors 304a, 304b together in electrical connection with the batteries 302 in between. Advantageously, the battery pack 300 is assembled by snap fitting the current collectors 304 together, without the need for screws or other threaded fasteners.

Returning to FIG. 3, each current collector 304 includes an inner layer 306; and an outer layer 308 adjacent the inner layer 306.

The inner layer 306 is electrically conductive and engages with the battery electrodes. The inner layer 306 is also thermally conductive. In particular, the inner layer 306 includes a polymeric base material with added graphene and metal powder such as nickel and/or copper.

The outer layer 308 is formed of non-electrically conductive material (i.e. and insulator). The outer layer 308 increases strength in the casing parts, without adding size or weight, with additives including graphene into a polymer. The outer layer 308 improves thermal dissipation away from the battery cell terminals without affecting the electrical current collection.

Turning to FIG. 4, the snap fastening means 400 includes posts 402 extending between the current collectors 304. The posts 402 extend between gaps formed by adjoining batteries 302 in the array. Each post 402 includes a resilient head 404 for squeezably inserting through a hole 406 in the upper current collector 304b. The head 404 includes a tapered apex to facilitate insertion in the hole 406, and is split. so that the two head halves come together when passing through the hole 406 before separating again on the other side.

Each post 402 fixedly extends from the lower current collector 304a, and is integrally formed (i.e. molded) with the lower current collector 304a. Accordingly, the battery pack housing includes only two parts. The underside of the head 404 stops inadvertent separation of the current collectors 304. However, the snap fastening means 400 is releasable whereby a tool can be used to compress the head 404 to purposively withdraw it from the hole 406. The top plate 304b can be removed without affecting the structural integrity of the top plate 304b or bottom plate 304a with the use of a separate part which when assembled to the top plate 304a squeezes the top of the “male” parts 404 to allow the top plate 304b to be removed.

The battery pack 300 combines the functions of several existing battery casing parts into one, reduces development time, reduces cost, improves performance of the battery, eliminates the necessity for weldable tabs in electric vehicle battery packs, and eliminates several assembly processes.

The battery pack 300 design provides up to 5 securing points around each battery cell, eliminates the requirement for external fasteners, allows for the reuse of parts at the end of the battery cell's life, allows for battery pack repair without damaging casing parts, eliminates several assembly processes, increases safety to for assembly staff during assembly, and increases the overall safety of the battery module 300.

A method for assembling the battery pack 300 is briefly described.

The method involves forming each like current collector 304 by joining the inner layer 306 and the outer layer 308. The inner layer 306 is formed by initially forming a solid panel, and then bonding a liquid to the solid panel which advantageously increases electrical conductivity.

The method then involves snap fastening the lower current collector 304a engaging with negative electrodes of the batteries 302 to the upper current collector 304b engaging with positive electrodes of the batteries 302 using the fastening means 400.

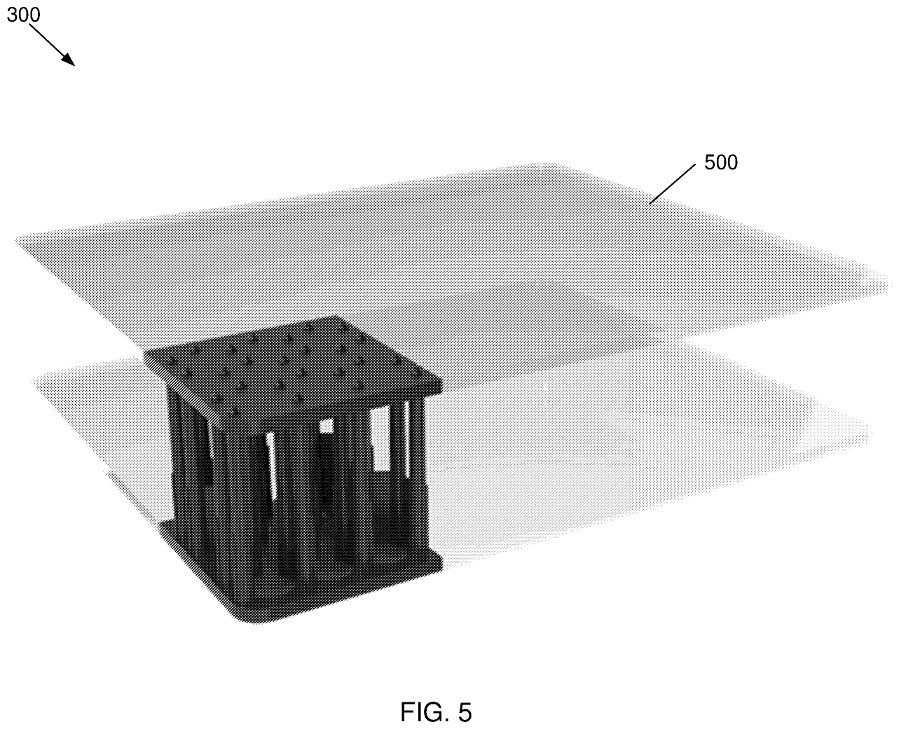

FIG. 5 shows the assembled battery pack 300, with the grey box 500 representing the overall size of the battery pack 300.

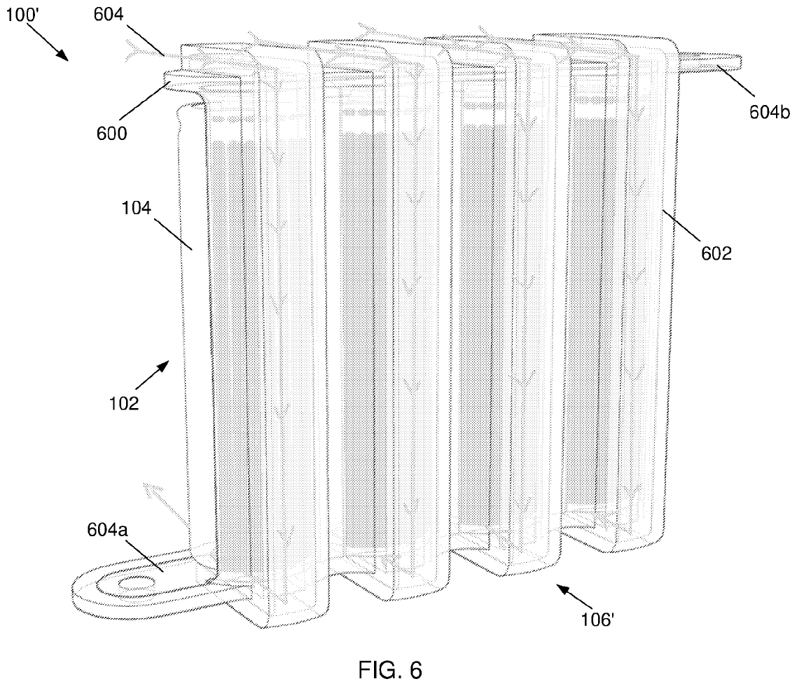

FIG. 6 shows another battery assembly 100′ similar to the assembly 100 of FIG. 1.

The assembly 100′ includes batteries 102 with outer cylindrical cases 104. Further, the assembly 100′ includes a heatsink 106′ which is used to sink heat from the batteries 102.

The heatsink 106′ includes a C-shaped receptacle 600 for receiving the batteries 102, and which is away from the centre or shaft of the battery cell 102 and out closer to the cell tabs where they are hottest. The heatsink 106′ further includes tubular conduits 602 extending around the outside of the C-shaped receptacle 600 and for conveying cooling fluid 604. The conduits 602 are aligned with respective batteries 102.

The conduits 602 and receptacle 600 are integrally formed, being injection molded from polymeric material which is an electrical insulator, although is thermally conductive. The conduits 602 and receptacle 600 contribute to a structurally robust heatsink 106′.

The heatsink 106′ further includes a pair of electrically conductive metal terminals 604a, 604b for engaging with respective electrodes of the batteries 102 at opposite ends. The terminals 604 are press embedded in the resilient receptacle 600, and can have protrusions to facilitate engagement with respective battery electrodes. The heatsink 106′ forms a clamp for clamping the batteries 102, and no screws or other fastening devices are required. This reduces the cost, complexity and number of parts.

A person skilled in the art will appreciate that many embodiments and variations can be made without departing from the ambit of the present invention.

The skilled person will understand that the battery block can be readily made to any width or depth.

The heatsink 106 can be formed to include graphene and polymeric material by injection molding, by rolling acrylic plastic or through a 3D printing process.

In one embodiment, the snap fastening means may be substituted by a slide, latch, or even thermalplast. The fastening means may include a sliding, compressive, expansive, metallic, adhesive or deformative fastener.

In one embodiment, the current collector 304 is formed to spring and lock onto a post that is not split.

In compliance with the statute, the invention has been described in language more or less specific to structural or methodical features. It is to be understood that the invention is not limited to specific features shown or described since the means herein described comprises preferred forms of putting the invention into effect.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

1-29. (canceled)

30. A battery pack, comprising:
batteries;
a first current collector for engaging with first electrodes of the batteries;
a second current collector for engaging with second electrodes of the batteries; and
a fastening arrangement for fastening the first current collector and the second current collector together, the fastening arrangement including one or more posts extending between the first current collector and the second current collector, each of the one or more posts including a head for inserting through one of the first current collector or the second current collector.

31. The battery pack of claim 30, wherein the first current collector and the second current collector are fastened together in electrical connection with the batteries located therebetween.

32. The battery pack of claim 30, wherein the one or more posts extend between gaps formed by adjoining batteries.

33. The battery pack of claim 30, wherein the head includes a tapered apex to facilitate insertion.

34. The battery pack of claim 30, wherein the head is split, or one of the first or second current collectors is formed to spring and lock onto one of the one or more posts that is not split.

35. The battery pack of claim 30, wherein each of the one or more posts fixedly extends from the same one of the first or second current collectors.

36. The battery pack of claim 35, wherein each of the one or more posts is integrally formed with the same one of the first or second current collectors.

37. The battery pack of claim 30, wherein the fastening arrangement is releasable.

38. The battery pack of claim 30, wherein the fastening arrangement includes one or more male and female parts.

39. The battery pack of claim 30, wherein each of the first current collector and the second current collector includes graphene and/or a polymeric material.

40. The battery pack of claim 30, wherein each of the first current collector and the second current collector includes an inner layer and an outer layer adjacent the inner layer.

41. The battery pack of claim 40, wherein the inner layer is electrically and/or thermally conductive and engages with the first and second electrodes.

42. The battery pack of claim 40, wherein the inner layer includes any one or more of polymeric material, graphene, metal powder, nickel, or copper.

43. The battery pack of claim 40, wherein the outer layer is formed of non-electrically conductive material.

44. A battery pack housing, comprising:
a first current collector for engaging with first electrodes of batteries;
a second current collector for engaging with second electrodes of the batteries; and
a fastening arrangement for fastening the first current collector and the second current collector together, the fastening arrangement including one or more posts extending between the first current collector and the second current collector, each of the one or more posts including a head for inserting through one of the first current collector or the second current collector.

45. A current collector for a battery pack housing, the current collector comprising graphene.

46. A method for assembling a battery pack, the battery pack including batteries; a first current collector configured for engaging with first electrodes of the batteries; a second current collector configured for engaging with second electrodes of the batteries; and a fastening arrangement including one or more posts configured to extend between the first current collector and the second current collector, each of the one or more posts including a head configured for inserting through one of the first current collector or the second current collector, the method comprising:
fastening the first current collector to the second current collector by inserting the heads of the one or more posts through at least one of the first or second current collectors.

47. The method of claim 46, further comprising forming each of the first current collector and the second current collector by joining an inner layer and an outer layer.

48. The method of claim 47, wherein the inner layer is formed by initially forming a solid panel, and then bonding a liquid to the solid panel that increases electrical conductivity.
